(19) United States
(12) Patent Application Publication
(10) Pub. No.: US 2012/0222037 A1
(43) Pub. Date: Aug. 30, 2012

(54) DYNAMIC REPROVISIONING OF RESOURCES TO SOFTWARE OFFERINGS

(75) Inventors: Jerome Labat, San Carlos, CA (US); Ramachandran Varadharajan, Fremont, CA (US); Sivakumar Prakash Thivakaram, Bangalore (IN); Srinivas Nimmagadda, San Jose, CA (US)

(73) Assignee: INTUIT INC., Mountain View, CA (US)

(21) Appl. No.: 13/034,475

(22) Filed: Feb. 24, 2011

(51) Int. Cl. G06F 9/46

(52) U.S. Cl. 718/104

(57) ABSTRACT

The disclosed embodiments provide a system that facilitates the maintenance and execution of a software offering. During operation, the system obtains a policy change associated with a service definition of the software offering. Next, the system updates one or more requirements associated with the software offering based on the policy change. Finally, the system uses the updated requirements to dynamically reprovision one or more resources for use by the software offering during execution of the software offering.

### RELATED APPLICATION

The subject matter of this application is related to the subject matter in a co-pending non-provisional application by inventors Jerome Labat, Ramachandran Varadharajan, Wilson W. Lau, and Thomas C. Bishop, entitled “Multidimensional Modeling of Software Offerings,” having Ser. No. 13/031,950 and filed on 22 Feb. 2011 (Attorney Docket No. INTU-115591).

The subject matter of this application is also related to the subject matter in a co-pending non-provisional application by inventors Jerome Labat, Ramachandran Varadharajan, Wilson W. Lau, and Thomas C. Bishop, entitled “Automatic Provisioning of Resources to Software Offerings,” having Ser. No. 13/031,968, and filed on 22 Feb. 2011 (Attorney Docket No. INTU-115592).

### BACKGROUND

### Related Art

The present embodiments relate to techniques for managing software offerings. More specifically, the present embodiments relate to techniques for dynamically reprovisioning resources to software offerings during execution of the software offerings.

Recent computing trends have shifted the processing and consumption of data and services to cloud computing systems. Such cloud computing systems allow software providers to deploy, execute, and manage software offerings on shared infrastructure resources such as servers, network equipment, platform-virtualization software, and/or data-center space. Furthermore, such resources may be dynamically provisioned and/or scaled, thus enabling consumption of the resources as services.

For example, a cloud computing provider may provide virtualized storage, network, and/or computing resources to multiple cloud computing customers. The cloud computing customers may deploy software offerings on the virtualized resources and pay the cloud computing provider only for resources consumed by the software offerings. As a result, the cloud computing customers may avoid capital expenditures associated with purchasing, setting up, and/or managing the underlying hardware and software. Furthermore, the centralization and sharing of infrastructure resources may improve the resources' utilization rates and management overhead.

Hence, the deployment, execution, and management of software offerings may be facilitated by mechanisms for dynamically allocating and configuring infrastructure resources used by the software offerings.

### SUMMARY

The disclosed embodiments provide a system that facilitates the maintenance and execution of a software offering. During operation, the system obtains a policy change associated with a service definition of the software offering. Next, the system updates one or more requirements associated with the software offering based on the policy change. Finally, the system uses the updated requirements to dynamically reprovision one or more resources for use by the software offering during execution of the software offering.

In some embodiments, the policy change is associated with a level of security, an architecture, a feature, a service component, or a quality-of-service (QoS) attribute.

In some embodiments, the QoS attribute is at least one of a reliability, an availability, a capacity, a scalability, and a response time.

In some embodiments, using the updated requirements to dynamically reprovision one or more resources for use by the software offering during execution of the software offering involves obtaining a set of available resources for use by the software offering, and reallocating the one or more resources to the software offering based on the updated requirements and the available resources.

In some embodiments, each of the one or more resources is at least one of a computing resource, a storage resource, a network resource, and a monitoring resource.

In some embodiments, reallocating the computing resource involves at least one of:
(i) changing a number of computing service containers in the software offering;
(ii) resizing a computing service container in the software offering; and
(iii) relocating the computing service container within the available resources.

In some embodiments, reallocating the storage resource involves at least one of:
(i) changing a number of storage service containers in the software offering;
(ii) resizing a storage service container in the software offering; and
(iii) relocating the storage service container within the available resources.

In some embodiments, reallocating the network resource involves at least one of:
(i) changing a set of connections between a set of service components;
(ii) modifying a virtual network used by the software offering; and
(iii) modifying a load-balancing technique in the virtual network.

In some embodiments, the monitoring resource is associated with infrastructure monitoring, application monitoring, customer-experience monitoring, or business monitoring.

### BRIEF DESCRIPTION OF THE FIGURES

FIG. 1 shows a schematic of a system in accordance with an embodiment.

FIG. 2 shows the dynamic reprovisioning of resources to a software offering in accordance with an embodiment.

FIG. 3 shows a flowchart illustrating the process of facilitating the maintenance and execution of a software offering in accordance with an embodiment.

FIG. 4 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for facilitating the maintenance and execution of a software offering. The software offering may correspond to an application that is deployed on one or more servers and accessed over a network connection. For example, the software offering may provide a web application, distributed application, and/or web service to users of the software offering.

More specifically, the disclosed embodiments provide a method and system for dynamically reprovisoning resources to the software offering during execution of the software offering. First, a policy change associated with a service definition of the software offering may be obtained. The policy change may be associated with a level of security, an architecture, a feature, a service component, and/or a quality-of-service (QoS) attribute of the software offering.

Next, one or more requirements associated with the software offering may be updated based on the policy change. The updated requirements may then be used to dynamically reprovision one or more resources for use by the software offering during execution of the software offering. For example, the updated requirements may be used to reallocate one or more resources to the software offering based on a set of available resources for use by the software offering. Such dynamic reprovisioning of resources may reduce overhead associated with managing, implementing, and tracking changes to the software offering, and in turn, facilitate closed-loop management of both the software offering and the resources.

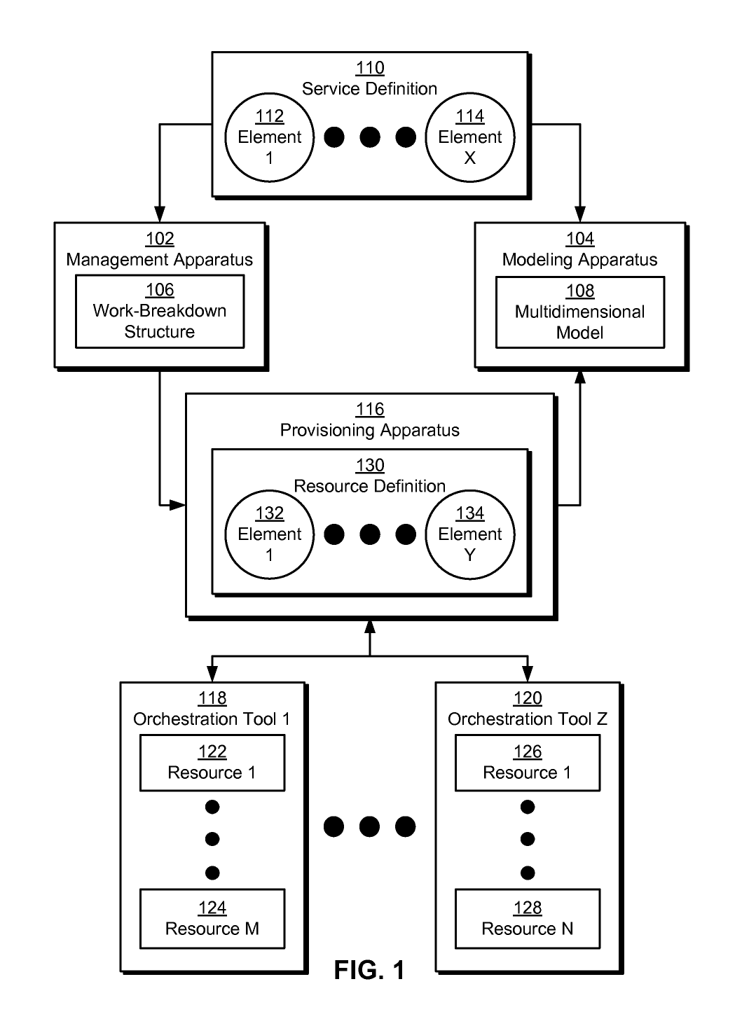

FIG. 1 shows a schematic of a system in accordance with an embodiment. As shown in FIG. 1, the system includes a management apparatus 102, a modeling apparatus 104, and a provisioning apparatus 116. Each of these components is discussed in further detail below.

In one or more embodiments, the system of FIG. 1 is used to manage the deployment and execution of a software offering on a set of resources (e.g., resource 1 122, resource m 124, resource 1 126, resource n 128). The software offering may correspond to a software program that performs tasks for a set of users. For example, the software offering may allow the users to collaborate on projects, file income taxes, manage personal or small business finances, and/or perform data mining on a target data set.

Furthermore, the software offering may be implemented using a client-server architecture. Components of the software offering may be deployed and executed on one or more servers (e.g., in a data center) and accessed from other machines using a locally installed executable, a command-line interface, and/or a web browser and network connection. In other words, the software offering may be implemented using a cloud computing system that is accessed over the Internet.

To enable execution of the software offering, users associated with the creation, deployment, and/or execution of the software offering may determine a set of requirements associated with the software offering. The users may then allocate resources (e.g., resource 1 122, resource m 124, resource 1 126, resource n 128) in the cloud computing system to components in the software offering and configure the allocated resources in a way that allows the executing software offering to meet the requirements. For example, a development team for the software offering may provide a policy specifying a level of availability, reliability, scalability, security, and/or response time in the software offering. Administrators for the cloud computing system may ensure compliance with the policy by allocating sufficient infrastructure resources to the software offering and/or configuring the resources to provide requisite levels of redundancy, security, and/or load balancing in the software offering.

Those skilled in the art will appreciate that the cloud computing system may use virtualization to deploy and execute the software offering on a set of shared resources. In particular, a number of orchestration tools (e.g., orchestration tool 1 118, orchestration tool z 120) may be used to virtualize and/or provision different types of resources in the cloud computing system. For example, a virtual machine monitor may allocate and/or manage computing resources by creating and executing virtual machines as abstractions of physical servers. Similarly, a virtual filer may combine storage resources from a variety of storage devices into a resource pool and allocate logical volumes of storage from the resource pool. Finally, network routers and/or switches may partition network resources into virtual local area networks (VLANs) that connect physical and/or virtual computing and/or storage resources in the cloud computing system.

Moreover, each orchestration tool may include functionality to dynamically reprovision resources in response to changes in the software offering and/or in demand for the resources. For example, a virtual machine monitor may instantiate a new virtual machine to enable the addition of a new web server to the software offering. The virtual machine monitor may also allocate a set of physical computing resources (e.g., processor, memory, etc.) to the virtual machine to enable execution of the web server on the resources. Finally, the virtual machine monitor may move the virtual machine to a different set of physical resources if the web server's resource requirements change and/or the physical resources (e.g., servers) used to execute the web server become overloaded.

In other words, the use of resources by the software offering may be managed by a number of disparate, independently acting orchestration tools. As a result, the cloud computing system may lack a comprehensive view of dependencies between software components in the software offering and the hardware resources used to execute the software components. For example, the cloud computing system may lose track of resources allocated to the software offering once the orchestration tools begin reallocating and/or reprovisioning the resources.

Such lack of dependency information may cause problems with tracking and managing events and/or failures in the cloud computing system. For example, a server outage in the cloud computing system may require manual intervention by administrators to determine the set of hardware and software components affected by the outage and/or perform corrective actions that enable recovery from the server outage.

In one or more embodiments, the system of FIG. 1 reduces complexity associated with managing requirements and dependencies in the software offering by creating a multidimensional model 108 of the software offering and using multidimensional model 108 to manage the deployment and execution of the software offering. As shown in FIG. 1, multidimensional model 108 may be created from a service definition 110 of the software offering and a resource definition 130 of resources available for use by the software offering.

Service definition 110 may be obtained from a user (e.g., developer, architect, etc.) associated with the creation and/or development of the software offering. More specifically, service definition 110 may correspond to a logical representation of the software offering in terms of the software offering's configuration, topology, policies, and/or QoS attributes. As a result, elements (e.g., element 1 112, element x 114) of service definition 110 may include one or more tiers, a set of service components, and/or a set of connections. For example, an architect of the software offering may provide service definition 110 by inputting the number of tiers, level of security, software-development-lifecycle stage, and/or software stack associated with the software offering into a user interface provided by management apparatus 102.

On the other hand, resource definition 130 may be obtained from administrators and/or orchestration tools of the cloud computing system and correspond to a logical representation and/or division of available infrastructure resources in the cloud computing system in terms of the resources' locations, states, and/or utilization. Elements (e.g., element 1 132, element y 134) of resource definition 130 may thus represent physical and/or virtual resources, resource clusters, security zones, hosting segments, and/or locations in the cloud computing system. For example, an administrator may manually populate resource definition 130 with an inventory of physical and/or virtual resources in the cloud computing system, or provisioning apparatus 116 may receive notifications of changes to resources (e.g., addition of new resources, removal of existing resources) in the cloud computing system from the orchestration tools (e.g., virtual machine monitors, virtual filers) and update resource definition 130 accordingly.

To create multidimensional model 108, modeling apparatus 104 may map a first set of elements (e.g., element 1 112, element x 114) from service definition 110 to a second set of elements (e.g., element 1 132, element y 134) from resource definition 130. The mappings may represent dependencies of the first set of elements on the second set of elements. For example, a mapping from a service component in service definition 110 to a resource in resource definition 130 may indicate the allocation of the resource to the service component by an orchestration tool. Creation of multidimensional models for software offerings is discussed in a co-pending non-provisional application by inventors Jerome Labat, Ramachandran Varadharajan, Wilson W. Lau, and Thomas C. Bishop, entitled “Multidimensional Modeling of Software Offerings,” having Ser. No. 13/031,950 and filed on 22 Feb. 2011 (Attorney Docket No. INTU-115591), which is incorporated herein by reference.

In one or more embodiments, the creation of multidimensional model 108 involves the identification of a set of requirements associated with the software offering from service definition 110, as well as the subsequent allocation of a subset of the resources from resource definition 130 to service components in service definition 110 based on the requirements. In particular, management apparatus 102 may determine the software offering's requirements from a set of policies in service definition 110 and store the requirements in a work-breakdown structure 106. The policies may include a software-development-lifecycle policy, a security policy, a software-template policy, a QoS policy, and/or a structural policy. The requirements may thus specify the amount and/or configuration of resources required to satisfy the policies.

Next, provisioning apparatus 116 may use work-breakdown structure 106 to automatically provision a set of resources for use by the software offering without requiring manual configuration of the resources by a user (e.g., administrator). For example, provisioning apparatus 116 may use work-breakdown structure 106 to create a set of service containers for hosting the software offering. Provisioning apparatus 116 may then allocate resources to the service containers by requesting the required amounts and/or configurations of resources from the corresponding orchestration tools. Automatic provisioning of resources to software offerings is discussed in a co-pending non-provisional application by inventors Jerome Labat Ramachandran Varadharajan, Wilson W. Lau, and Thomas C. Bishop, entitled “Automatic Provisioning of Resources to Software Offerings,” having Ser. No. 13/031,968, and filed on 22 Feb. 2011 (Attorney Docket No. INTU-115592), which is incorporated herein by reference.

As mentioned previously, multidimensional model 108 may include dependencies between service components in service definition 110 and resources in resource definition 130. Consequently, modeling apparatus 104 may create multidimensional model 108 by mapping resources allocated by provisioning apparatus 116 to the service components to which the resources were allocated.

Modeling apparatus 104 may also update the mappings based on changes to the provisioned resources. For example, resources provisioned to service components may change as the orchestration tools allocate new resources, deallocate currently allocated resources, and/or use different sets of physical resources to execute virtualized resources (e.g., virtual machines, logical volumes, VLANs, etc.). Such changes may be obtained by provisioning apparatus 116 through querying and/or monitoring of the orchestration tools. The changes may also be used by provisioning apparatus 116 to update resource definition 130. The updates may then be propagated to multidimensional model 108 via modeling apparatus 104.

Because multidimensional model 108 contains an up-to-date representation of service components, resources, and dependencies in the software offering, the system of FIG. 1 may facilitate management of the software offering within the cloud computing system. For example, multidimensional model 108 may facilitate the automatic deployment of the software offering on the allocated resources, identification of resources allocated to the software offering, identification of failures during execution of the software offering, and/or management of changes associated with the software offering or the resources. In other words, the creation and update of multidimensional model 108 may reduce complexity and/or overhead associated with configuration management, fault diagnosis and remediation, deployment, and/or resource provisioning in the software offering.

Those skilled in the art will appreciate that policies and/or requirements associated with the software offering may change over time as the software offering is upgraded, redefined, and/or otherwise modified. In turn, the implementation of such changes may result in changes to the allocation of resources to the software offering. For example, increased usage of the software offering may necessitate a corresponding increase in the software offering's capacity to maintain requisite levels of reliability, availability, and/or response time. Similarly, a change in the software offering's security level, functionality, and/or architecture may require resources used by the software offering to be relocated and/or reconfigured.

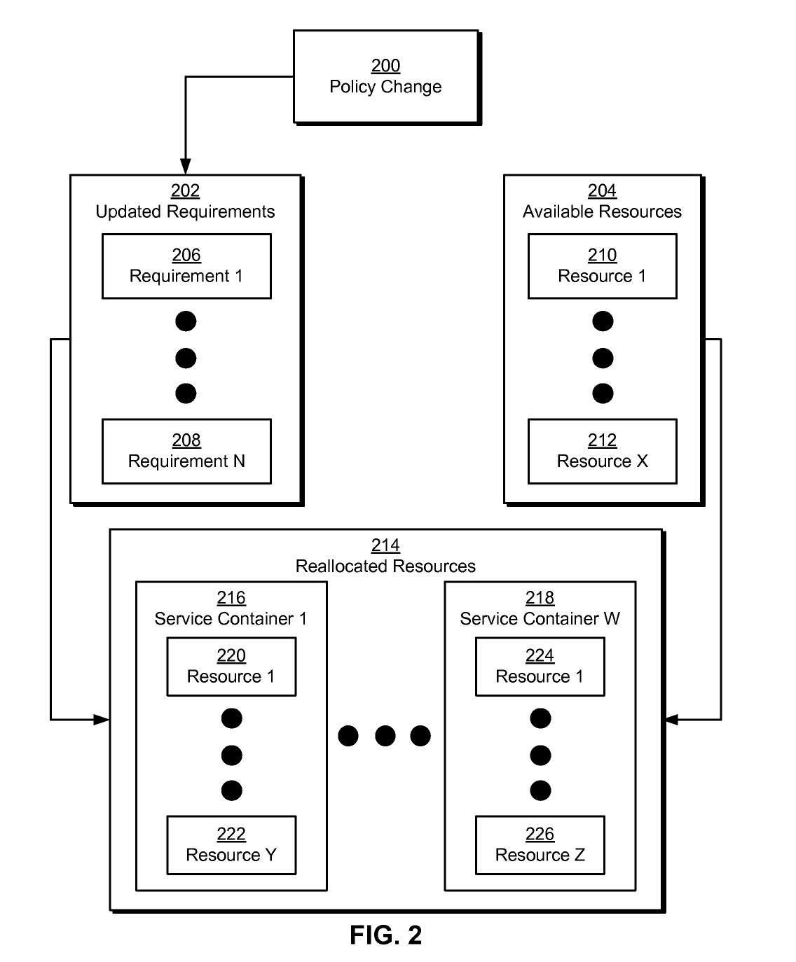

As mentioned above, provisioning apparatus 116 and/or modeling apparatus 104 may include functionality to track dynamic changes made by the orchestration tools to the allocated resources. Conversely, management apparatus 102 and/or provisioning apparatus 116 may trigger the dynamic reprovisioning of resources to the software offering by the orchestration tools to maintain adherence to the software offering's policies and/or requirements, as discussed in further detail below with respect to FIG. 2.

First, management apparatus 102 may obtain policy changes associated with service definition 110 as the software offering executes and/or evolves. Each policy change may be associated with a level of security, an architecture, a feature, a service component, and/or a QoS attribute of the software offering.

Next, management apparatus 102 may update one or more requirements associated with the software offering based on the policy changes. For example, a policy change corresponding to an increase in the software offering's level of security may be used by management apparatus 102 to update a requirement specifying the security zone in which one or more components of the software offering are to execute.

Finally, provisioning apparatus 116 may use the updated requirements to dynamically reprovision one or more resources for use by the software offering during execution of the software offering. In particular, provisioning apparatus 116 may obtain a set of available resources for use by the software offering from resource definition 130 and reallocate resources to the software offering based on the updated requirements and the available resources. The reallocated resources may then be identified by provisioning apparatus 116 and used to update resource definition 130 and multidimensional model 108. Consequently, the system of FIG. 1 may include functionality to automate the implementation, management, and tracking of changes to the software offering during execution of the software offering.

FIG. 2 shows the dynamic reprovisioning of resources to a software offering in accordance with an embodiment. As mentioned above, the reprovisioning may be triggered by a policy change 200 associated with a service definition of the software offering, such as service definition 110 of FIG. 1. As discussed in the above-referenced applications, the service definition may contain a set of policies for the software offering, such as a software-development-lifecycle policy, a structural policy, a security policy, a software-template policy, and/or a QoS policy.

Changes to the software offerings' features, architecture, security, and/or QoS attributes may also be reflected in the policies within the service definition. For example, the addition of a new tier to the software offering's architecture may be represented by the creation of a new tier node in the service definition, and the use of a new service by the software offering may be represented by the creation of a new service node in the service definition. On the other hand, the security policy for an existing tier or service node may be updated to specify a higher level of security for the tier represented by the tier node. Finally, one or more QoS attributes within a node may be updated to indicate changes to the expected reliability, availability, capacity, scalability, and/or response time of the tier and/or service associated with the node. In other words, policy change 200 may represent a change to the service definition during deployment and/or execution of the software offering.

As discussed above, policies in the service definition may be used to create a work-breakdown structure (e.g., work-breakdown structure 106 of FIG. 1) that is used to allocate resources to the software offering from a set of available resources 204 (e.g., resource 1 210, resource x 212). Along the same lines, a set of updated requirements 202 (e.g., requirement 1 206, requirement n 208) may be created based on policy change 200 and used to reallocate resources to the software offering to maintain coherence with the service definition as the service definition changes. For example, policy change 200 may be used by a provisioning apparatus (e.g., provisioning apparatus 116 of FIG. 1) to create a new work-breakdown structure and/or update an existing work-breakdown structure for the software offering.

The provisioning apparatus may then obtain a set of available resources 204 for use by the software offering and reallocate one or more resources 214 to the software offering based on updated requirements 202 and available resources 204. For example, the provisioning apparatus may maintain a list of available resources 204 within a resource definition (e.g., resource definition 130). The provisioning apparatus may then compare a work-breakdown structure containing updated requirements 202 with available resources 204 to determine if the available resources are sufficient to meet the updated requirements. If the software offering cannot be reprovisioned adequately using available resources 204, the software offering is not reprovisioned from available resources 204.

If the software offering can be sufficiently reprovisioned from the available resources, updated requirements 202 are used to dynamically reprovision one or more resources from available resources 204 for use by the software offering during execution of the software offering. For example, the provisioning apparatus may reallocate one or more resources to the software offering based on updated requirements 202 and available resources 204 by querying the corresponding orchestration tool(s) for the resources. Such automatic modification of the software offering's resource usage may reduce the amount of manual configuration and/or input required of a user (e.g., administrator) to implement changes to the software offering.

In one or more embodiments, reallocated resources 214 (e.g., resource 1 220, resource y 222, resource 1 224, resource z 226) include a physical and/or virtual computing resource, storage resource, network resource, and/or monitoring resource. Moreover, reallocation of each type of resource may affect the allocation, configuration, and/or behavior of the other types of resources, as discussed below.

First, the computing resource may be reallocated by changing a number of computing service containers (e.g., service container 1 216, service container w 218) in the software offering, resizing one or more computing service containers in the software offering, and/or relocating one or more computing service containers within available resources 204. For example, increased reliability, capacity, scalability, and/or functionality in the software offering may be implemented by creating a new computing service container and hosting a new web and/or application server in the new computing service container. Conversely, additional server resources (e.g., processors, memory, etc.) may be allocated to an existing computing service container to increase the performance, capacity, and/or scalability of the existing computing service container. The existing computing service container may also be moved to a different physical server, rack, resource cluster, and/or data center to reduce the load on the computing resources on which the computing container currently executes and/or to change the level of security associated with the computing container.

Similarly, the storage resource may be reallocated by changing a number of storage service containers (e.g., service container 1 216, service container w 218) in the software offering, resizing one or more storage service containers in the software offering, and/or relocating one or more storage service containers within the available resources. For example, a new storage service container may be created to host a new database for batch processing in the software offering (e.g., by an application server). On the other hand, the capacity of an existing storage service container may be increased or decreased in response to changes in the storage requirements of another service component in the software offering. The existing storage service container may also be relocated to a different physical volume to increase the response time and/or redundancy of the storage service container and/or reduce the load on the physical volume on which the storage service container currently executes.

On the other hand, the network resource may be reallocated by changing a set of connections between a set of service components, modifying one or more virtual networks in the software offering, and/or modifying a load-balancing technique in one or more virtual networks. For example, a new virtual network (e.g., virtual local area network (VLAN)) may be created by assigning a set of Internet Protocol (IP) addresses and/or domain names to computing and/or storage service containers and enabling communication among the computing and/or storage service containers using the IP addresses. Furthermore, a service component (e.g., application server, web server, database, etc.) may be added to an existing virtual network by adding the computing and/or storage service container in which the service component is hosted to a network service container (e.g., service container 1 216, service container w 218) corresponding to the existing virtual network. Changes to service components in the virtual networks may additionally be reflected in the load-balancing techniques of the virtual networks; for example, an increase in the number of web servers in a VLAN may result in a different distribution of workload across the web servers.

Finally, the monitoring resource may be reallocated by changing a type and/or level of monitoring in the software offering. For example, the monitoring resource may be associated with infrastructure monitoring, application monitoring, customer-experience monitoring, and/or business monitoring of the software offering. As a result, a new monitoring resource may be added in response to the required use of a new type of monitoring in the software offering in policy change 200. Along the same lines, use of an existing monitoring system in monitoring the software offering may be modified to increase or decrease the amount of monitoring of the software offering performed by the monitoring system.

As with the initial provisioning of resources to the software offering, reprovisioning of resources to the software offering may be tracked by a multidimensional model (e.g., multidimensional model 108 of FIG. 1) of the software offering. For example, the provisioning apparatus may continuously query and/or monitor the orchestration tools for changes to resources allocated to the software offering. The provisioning apparatus may also update a resource definition (e.g., resource definition 130 of FIG. 1) of the software offering to reflect the changes. Finally, the changes may be propagated from the resource definition to the multidimensional model via a modeling apparatus (e.g., modeling apparatus 104 of FIG. 1). Consequently, such dynamic management, implementation, and/or tracking of changes to the software offering may enable the closed-loop management of both the software offering and the resources throughout the software development lifecycle of the software offering.

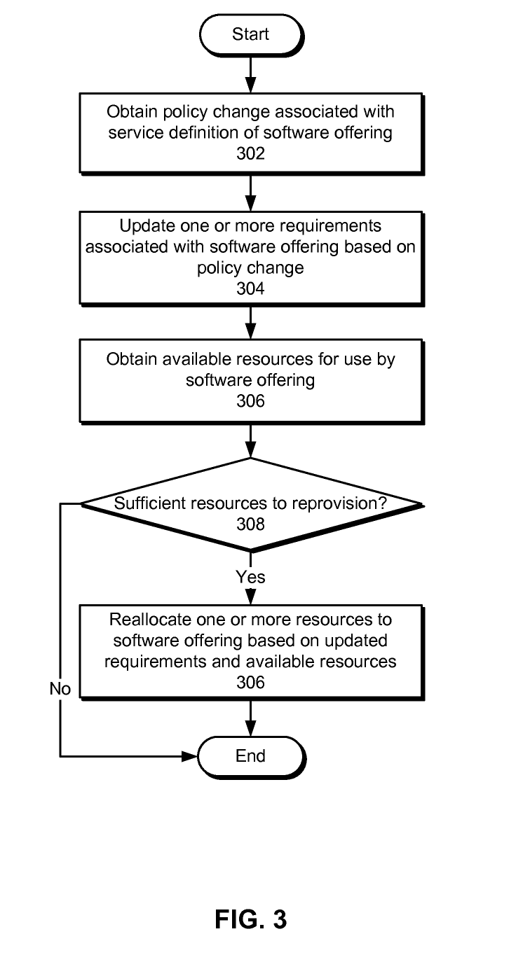

FIG. 3 shows a flowchart illustrating the process of facilitating the maintenance and execution of a software offering in accordance with an embodiment. In one or more embodiments, one or more of the steps may be omitted, repeated, and/or performed in a different order. Accordingly, the specific arrangement of steps shown in FIG. 3 should not be construed as limiting the scope of the technique.

First, a policy change associated with a service definition of the software offering is obtained (operation 302). The policy change may be associated with a level of security, an architecture, a feature, a service component, and/or a QoS attribute (e.g., reliability, availability, capacity, scalability, response time) of the software offering.

Next, one or more requirements associated with the software offering are updated based on the policy change (operation 304). For example, an increase in the reliability, availability, capacity, scalability, and/or response time of a service component in the software offering may result in the update of a requirement related to the number of service containers, the resources allocated to a service container, and/or the location of a service container in the software offering.

A set of available resources for use by the software offering is also obtained (operation 306), and the available resources and updated requirements are used to determine if the available resources are sufficient to reprovision the software offering (operation 308). If the available resources are not sufficient, the software offering is not reprovisioned from the available resources.

If the available resources are sufficient, one or more resources are reallocated to the software offering based on the updated requirements and available resources (operation 310). In other words, the updated requirements may be used to dynamically reprovision one or more resources for use by the software offering during execution of the software offering. For example, a change in the software offering's level of security may result in the relocation of one or more resources, while a change in the software offering's architecture, functionality, and/or service components may trigger the creation, resizing, or removal of one or more service containers.

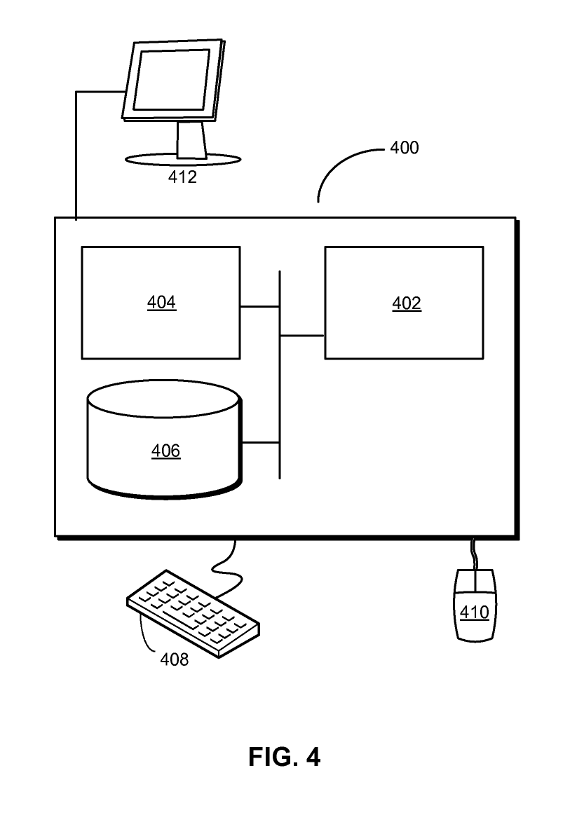

FIG. 4 shows a computer system 400 in accordance with an embodiment. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for facilitating the maintenance and execution of a software offering. The system may include a management apparatus that obtains a policy change associated with a service definition of the software offering and that updates one or more requirements associated with the software offering based on the policy change. The system may also include a provisioning apparatus that uses the updated requirements to dynamically reprovision one or more resources for use by the software offering during execution of the software offering.

In addition, one or more components of computer system 400 may be remotely located and connected to the other components over a network. Portions of the present embodiments (e.g., management apparatus, provisioning apparatus, etc.) may also be located on different nodes of a distributed system that implements the embodiments. For example, the present embodiments may be implemented using a cloud computing system that manages the deployment, execution, and maintenance of a software offering.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating the maintenance and execution of a software offering, comprising:
obtaining a policy change associated with a service definition of the software offering;
updating one or more requirements associated with the software offering based on the policy change; and
using the updated requirements to dynamically reprovision one or more resources for use by the software offering during execution of the software offering.

2. The computer-implemented method of claim 1, wherein the policy change is associated with at least one of:
a level of security;
an architecture;
a feature;
a service component; and
a quality-of-service (QoS) attribute.

3. The computer-implemented method of claim 2, wherein the QoS attribute is at least one of a reliability, an availability, a capacity, a scalability, and a response time.

4. The computer-implemented method of claim 1, wherein using the updated requirements to dynamically reprovision one or more resources for use by the software offering during execution of the software offering involves:
obtaining a set of available resources for use by the software offering; and
reallocating the one or more resources to the software offering based on the updated requirements and the available resources.

5. The computer-implemented method of claim 4, wherein each of the one or more resources is at least one of a computing resource, a storage resource, a network resource, and a monitoring resource.

6. The computer-implemented method of claim 5, wherein reallocating the computing resource involves at least one of:
changing a number of computing service containers in the software offering;
resizing a computing service container in the software offering; and
relocating the computing service container within the available resources.

7. The computer-implemented method of claim 5, wherein reallocating the storage resource involves at least one of:
changing a number of storage service containers in the software offering;
resizing a storage service container in the software offering; and
relocating the storage service container within the available resources.

8. The computer-implemented method of claim 5, wherein reallocating the network resource involves at least one of:
changing a set of connections between a set of service components;
modifying a virtual network used by the software offering; and
modifying a load-balancing technique in the virtual network.

9. The computer-implemented method of claim 5, wherein the monitoring resource is associated with at least one of infrastructure monitoring, application monitoring, customer-experience monitoring, and business monitoring.

10. A system for facilitating the maintenance and execution of a software offering, comprising:
a management apparatus configured to:
obtain a policy change associated with a service definition of the software offering; and
update one or more requirements associated with the software offering based on the policy change; and
a provisioning apparatus configured to use the updated requirements to dynamically reprovision one or more resources for use by the software offering during execution of the software offering.

11. The system of claim 10, wherein the policy change is associated with at least one of:
a level of security;
an architecture;
a feature;
a service component; and
a quality-of-service (QoS) attribute.

12. The system of claim 10, wherein using the updated requirements to dynamically reprovision one or more resources for use by the software offering during execution of the software offering involves:
obtaining a set of available resources for use by the software offering; and
reallocating the one or more resources to the software offering based on the updated requirements and the available resources.

13. The system of claim 12, wherein each of the one or more resources is at least one of a computing resource, a storage resource, a network resource, and a monitoring resource.

14. The system of claim 13, wherein reallocating the computing resource involves at least one of:
changing a number of computing service containers in the software offering;
resizing a computing service container in the software offering; and
relocating the computing service container within the available resources.

15. The system of claim 13, wherein reallocating the storage resource involves at least one of:
changing a number of storage service containers in the software offering;
resizing a storage service container in the software offering; and
relocating the storage service container within the available resources.

16. The system of claim 13, wherein reallocating the network resource involves at least one of:
changing a set of connections between a set of service components;
modifying a virtual network used by the software offering; and
modifying a load-balancing technique in the virtual network.

17. The system of claim 13, wherein the monitoring resource is associated with at least one of infrastructure monitoring, application monitoring, customer-experience monitoring, and business monitoring.

18. A computer-readable storage medium storing instructions that when executed by a computer cause the computer to perform a method for facilitating the maintenance and execution of a software offering, the method comprising:
obtaining a policy change associated with a service definition of the software offering;
updating one or more requirements associated with the software offering based on the policy change; and
using the updated requirements to dynamically reprovision one or more resources for use by the software offering during execution of the software offering.

19. The computer-readable storage medium of claim 18, wherein the policy change is associated with at least one of:
a level of security;
an architecture;
a feature;
a service component; and
a quality-of-service (QoS) attribute.

20. The computer-readable storage medium of claim 18, wherein using the updated requirements to dynamically reprovision one or more resources for use by the software offering during execution of the software offering involves:
obtaining a set of available resources for use by the software offering; and
reallocating the one or more resources to the software offering based on the updated requirements and the available resources.

21. The computer-readable storage medium of claim 20, wherein each of the one or more resources is at least one of a computing resource, a storage resource, a network resource, and a monitoring resource.

22. The computer-readable storage medium of claim 21, wherein reallocating the computing resource involves at least one of:
changing a number of computing service containers in the software offering;
resizing a computing service container in the software offering; and
relocating the computing service container within the available resources.

23. The computer-readable storage medium of claim 21, wherein reallocating the storage resource involves at least one of:
changing a number of storage service containers in the software offering;
resizing a storage service container in the software offering; and
relocating the storage service container within the available resources.

24. The computer-readable storage medium of claim 21, wherein reallocating the network resource involves at least one of:
changing a set of connections between a set of service components;
modifying a virtual network used by the software offering; and
modifying a load-balancing technique in the virtual network.

25. The computer-readable storage medium of claim 21, wherein the monitoring resource is associated with at least one of infrastructure monitoring, application monitoring, customer-experience monitoring, and business monitoring.
